(19) United States
(12) Patent Application Publication
(10) Pub. No.: US 2004/0193759 A1
(43) Pub. Date: Sep. 30, 2004

(54) Method and system for providing a smart card scripting tool

(76) Inventors: Roger M. Scott, Newport News, VA (US); Jeffrey W. Okuhara, Yorktown, VA (US); Thomas J. Barr, Williamsburg, VA (US); Robert J. Nering, Mililani, HI (US); Michael C. Moon, Williamsburg, VA (US)

Correspondence Address: Finnegan, Henderson, Farabow,, Garrett & Dunner, L.L.P., 1300 I Street, N.W., Washington, DC, 20005-3315, US

(21) Appl. No.: 10/735,628

(22) Filed: Dec. 16, 2003

Related U.S. Application Data
(60) Provisional application No. 60/458,427, filed on Mar. 31, 2003.

(51) Int. Cl. G06F 3/00

(52) U.S. Cl. 710/36

(57) ABSTRACT

A method, apparatus and computer-readable medium for facilitating application sharing. In operation, a user selects one of a plurality of applications associated with a first data source, wherein each of the plurality of data source applications has a plurality of data elements. The user then selects one of a plurality of applications associated with a data target, wherein each of the plurality of data target applications has a plurality of data entry fields. The present invention then maps a data element from the first data source to a data entry field using a drag and drop operation, wherein a data element on a second data source corresponding to the mapped data element may be automatically associated with the data entry field of the selected data target application.

### CROSS-REFERENCE TO RELATED APPLICATIONS

This application claims the benefit of U.S. provisional application Serial No. 60/458,427 (Attorney Docket No. 07948-6001-00000), filed Mar. 31, 2003, the disclosure of which is hereby incorporated by reference herein.

### DESCRIPTION OF THE INVENTION

1. Field of the Invention

The present invention relates generally to a method and system for communicating data from a data source to a destination and, more particularly, to a tool for interfacing a smart card with one of a plurality of application programs.

2. Background of the Invention

The functions of communicating data and converting data have often been isolated from each other. An early means of data communications involving computers, for example, was manual data entry by a human being. In particular, a person using some input device, such as a keyboard, typically inputted data into a program running on a computer, which stored the information.

Through time, data communication has been facilitated using a variety of media. For example, the output from one computer could be stored in a portable form, which could then be input into another computer. Punched cards could be created by a computer, or a keypunch, and read by another computer, for example. Magnetic tape, disk packs and floppy disks have likewise been useful for transporting data between machines. Smart cards have more recently become an extremely popular medium for communicating data to one or more computers.

A smart card is a thin card embedded with a memory device (volatile and/or non-volatile) and associated programmable or non-programmable logic. Unlike the mag card that merely stores “static” information (e.g., a credit card account number), a smart card can add, delete and otherwise manipulate information stored on the card. Accordingly, smart cards are capable of storing and executing applications to carry out one or more functions within a smart card.

Currently, most smart cards interface with card readers in a manner compliant with the International Standards Organization/international Electrotechnical Commission (ISO) 7816 standard (hereinafter “ISO-7816 standard”). Card readers in turn communicate with host computers using interfaces such as the RS-232, the PS/2 or the Universal Serial Bus (USB). Current host computers typically require the implementation and utilization of a specific driver such as the RS 232, the PS/2 or the USB driver, to communicate with the card readers. The card reader in turn communicates with the card in accordance with ISO-7816.

A smart card typically consists of an operating system and a file structure. The operating system is compliant with the ISO 7816 standard, but it is generally proprietary. The file structure or applets (JAVA) are typically developed for a specific application or program. The differing formats adopted by different smart card providers for different applications seriously limits the inter-operability of present day smart card systems. In other words, a smart card supplied by a given card provider for a particular program and configured to fulfill a particular function, will generally not be compatible with the hardware and operating systems of different card providers. Nor will the card generally be compatible with hardware and operating systems designed to fulfill a different function, or any of the potentially limitless number of different programs or functions required by the many different card providers, card issuers or users of the different functions and programs.

Further exacerbating the problem of limited interoperability is the fact that once a designer has invested time and effort into implementing an interface program for a particular smart card, the designer may be less inclined to develop another interface for a different smart card particularly in consideration of the additional time investment required. The low-number of applications/programs supported by each card and the lack of flexibility inherent in the current approach to interfacing multiple smart card systems has seriously limited the functionality and interoperability of present day smart card technology.

When an existing application on a data communication network is not designed to operate with a particular smart card, several different methods may be used to facilitate communication between the application and the smart card. A brute force method would be to use a human being. Output from the smart card could be printed on some medium such as paper and then manually re-keyed into another computer. This conversion method is undesirable because it is so manually intensive.

A method requiring a higher level of sophistication may be to write a program dedicated to converting the smart card data from one format to another. For example, a program could be written for use on a particular operating system that could read one data storage format and write another. To do this, a person must have knowledge of: (1) the internals of the smart card and the conversion products; and (2) the file/directory structure of the local computer/network. Such information is often highly technical and beyond the ability of most users. Even if not beyond the user, it can be time-consuming to understand. While this method may require less manpower than the previous method, it likely requires the efforts of experienced computer programmers. In the end, this method may cost as much or more than the brute force method.

Accordingly, there has been a need for method and apparatus to facilitate data communication between data sources and data targets even when the data communication involves data conversion, and to provide flexibility in doing so.

### SUMMARY OF THE INVENTION

In accordance with the present invention, a method, apparatus and computer-readable medium for communicating data from a plurality of data sources to a plurality of data targets are provided. In operation, a user selects one of a plurality of applications associated with a first data source, wherein each of the plurality of data source applications has a plurality of data elements. The user then selects one of a plurality of applications associated with a data target, wherein each of the plurality of data target applications has a plurality of data entry fields. A data element is then mapped from the first data source to a data entry field using a drag and drop operation, wherein a data element on a second data source corresponding to the mapped data element may be automatically associated with the data entry field of the selected data target application without requiring modification of the data target.

Additional features and advantages consistent with the invention will be set forth in part in the description that follows, and in part will be obvious from the description, or may be learned by practice of the invention. The features and advantages consistent with the invention will be realized and attained by means of the elements and combinations particularly pointed out in the appended claims.

It is to be understood that both the foregoing general description and the following detailed description are exemplary only and not restrictive of the invention as claimed.

### BRIEF DESCRIPTION OF THE DRAWINGS

The accompanying drawings, which are incorporated in and constitute a part of this specification, illustrate several implementations, and together with the description, serve to explain the principles of the invention.

FIG. 1 is a depiction of an exemplary data processing network in which the present invention may be practiced;

FIG. 2 is a depiction of a computer upon which the present invention may operate;

FIG. 3 is a flowchart depicting the operation of one embodiment of the present invention;

FIG. 4 is a flowchart depicting the process of logging onto one embodiment of the present invention;

FIG. 5 is a flowchart depicting the process of selecting a card system and selecting an application in accordance with one embodiment of the present invention;

FIG. 6A is an exemplary list of data that may be used in the process of selecting a card system and selecting an application in accordance with one embodiment of the present invention;

FIG. 6B depicts an exemplary graphical user interface for selecting a card system and selecting an application in accordance with one embodiment of the present invention;

FIG. 7 is a graphical depiction of a user interface in accordance with one embodiment of the present invention;

FIG. 8 is a flowchart depicting the process of creating an output file in accordance with one embodiment of the present invention;

FIG. 9 is a flowchart depicting the process of mapping a source to a target in accordance with an exemplary embodiment; and

FIG. 10 is a flowchart depicting the process of mapping a target to a source in accordance with one embodiment of the present invention.

### DETAILED DESCRIPTION

In the following detailed description of at least one embodiment, reference is made to the accompanying drawings that form a part thereof, and in which is shown by way of illustration a specific embodiment in which the invention may be practiced. This embodiment is described in sufficient detail to enable those skilled in the art to practice the invention and it is to be understood that other embodiments may be utilized and that structural changes may be made without departing from the scope of the present invention. The following detailed description is, therefore, not to be taken in a limiting sense.

Turning first to the nomenclature of the specification, the detailed description, which follows, is represented largely in terms of processes and symbolic representations of operations performed by conventional computer components, including a central processing unit (CPU), memory storage devices for the CPU, and connected pixel-oriented display devices. These operations include the manipulation of data bits by the CPU and the maintenance of these bits within data structures residing in one or more of the memory storage devices. Such data structures impose a physical organization upon the collection of data bits stored within computer memory and represent specific electrical or magnetic elements. These symbolic representations are the means used by those skilled in the art of computer programming and computer construction to most effectively convey teachings and discoveries to others skilled in the art.

For the purposes of this detailed description, a process is generally a sequence of computer-executed steps leading to a desired result. These steps generally require logical manipulations of physical quantities. Usually, though not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, terms, objects, numbers, records, files or the like. It should be kept in mind, however, that these and similar terms should be associated with appropriate physical quantities for computer operations, and that these terms are merely conventional labels applied to physical quantities that exist within and during operation of the computer.

It should also be understood that manipulations within the computer are often referred to in terms such as adding, comparing, moving, etc., which are often associated with manual operations performed by a human operator. In other words, the operations described herein are machine operations performed in conjunction with a human operator or user who interacts with the computer. The machines used for performing operations consistent with the present invention include general-purpose digital computers or other similar computing devices.

In addition, it should be understood that the programs, processes, methods, etc., described herein are not related or limited to any particular computer or apparatus. Rather, various types of general-purpose machines may be used with programs constructed in accordance with the teachings described herein. Similarly, it may prove advantageous to construct specialized apparatus to perform the methods described herein by way of dedicated computer systems with hard-wired logic or programs stored in nonvolatile memory, such as read only memory.

The operating environment in which the present invention is used encompasses general distributed computing systems wherein general-purpose computers, workstations, or personal computers are connected via communication links of various types. In a client-server arrangement, programs and data are transmitted over the communication links by various members of the system.

For illustrative purposes, aspects of the invention are described in the context of a scripting tool that may be used to map data from one or more smart cards to a plurality of user applications. Another aspect of this invention is that the movement of map data into a target application is accomplished without modifying the target application. One of skill in the art will appreciate that the present invention may be used in other data mapping scenarios without departing from the spirit and scope of the present invention.

The examples described in the text may be accompanied by figures illustrating user interface displays that may be produced through use of a computer system to implement a scripting tool for interfacing a smart card with a plurality of user applications in accordance with the present invention. These too are illustrative and are not intended to limit the invention in any way.

Referring now to the drawings, in which like numerals represent like elements throughout the several figures, embodiments consistent with the present invention will be described.

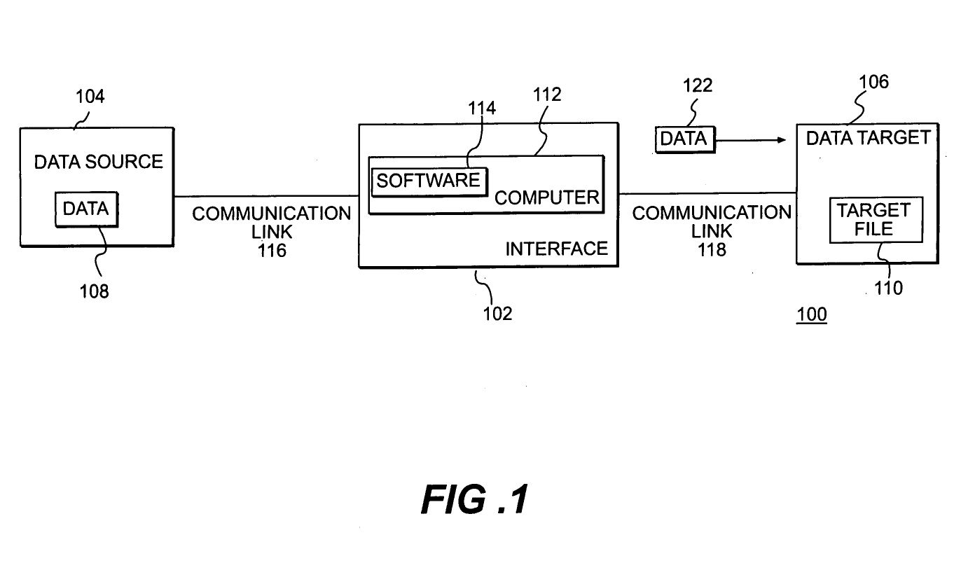

FIG. 1 shows a data processing network 100 in which embodiments consistent with the present invention may be practiced. Data processing network 100 includes a data source 104, an interface 102 and a data target 106. Interface 102 is further comprised of a computer system 112, which operates software 114.

The devices and computers shown in FIG. 1 comprise network 100, which may be, for example, a local area network (LAN), a wide area network (WAN), or the Internet. In network 100, the devices and computers are coupled together via one or more communication links. More specifically, data source 104 is connected to interface 102 via a communication link 116, and interface 102 is coupled to data target 106 via a communication link 118. Communication link 116 enables communication of data streams between interface 102 and data source 104, and communication link 118 enables communication of data streams between interface 102 and data target 106.

In operation, communication link 116 and communication link 118 reformat the data streams appropriately and relay the data streams to interface 102 and data target 106, respectively. Communication links 116 and 118 preferably accommodate several different communication protocols including Hypertext Transfer Protocol (HTTP) and File Transfer Protocol (FTP). In one embodiment, communication link 118 may communicate data streams to interface 102 and communication link 116 may communicate data streams from interface 102 to data source 104. Interface 102, data source 104 and data target 106 may be coupled to other computers/devices along other communication links (not shown), without departing from the spirit and scope of the present invention.

In one embodiment, data source 104 is a smart card reader and data 108 is data extracted from a smart card (not shown). Interface 102 is adapted to acquire data 108 from data source 104, transform (e.g., convert format and/or filter data) source data 108 if desired, and transport transformed data 122 to data target 106, and ultimately to a target file 110 located in data target 106. In this way, interface 102 facilitates interoperability between data 108 and target file 110.

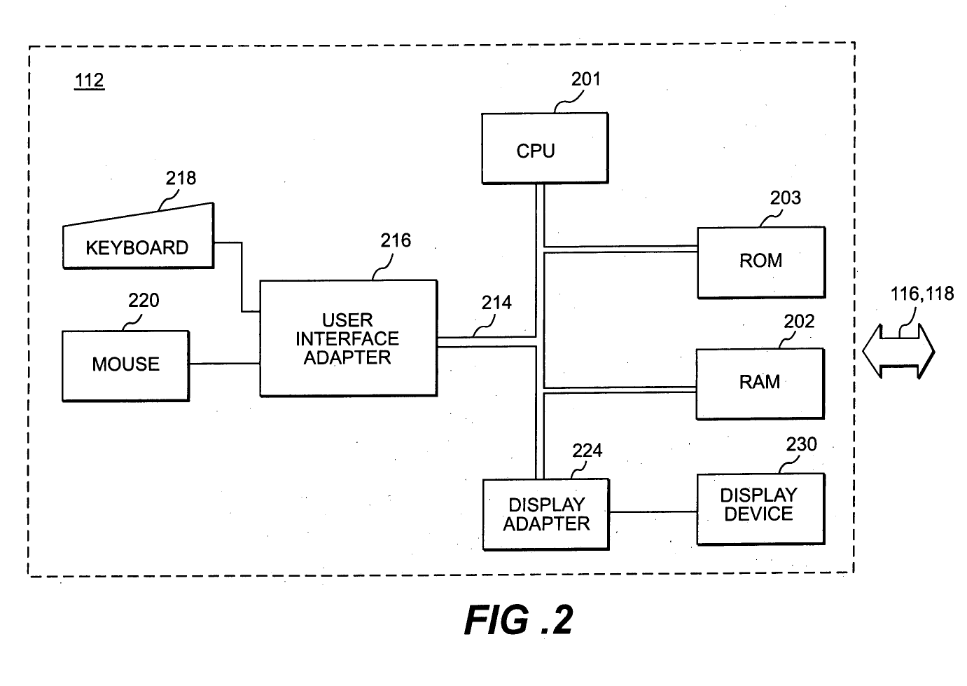

FIG. 2 illustrates a block diagram of computer 112 as shown in FIG. 1. Computer 112 includes a CPU 201, a RAM 202, a ROM 203, a bus 214, a user interface adapter 216, a keyboard 218, a mouse 220, a display adapter 224 and a display device 230. Communication links 116 and 118 link computer 112 to network 100. CPU 201 is preferably connected to each of the elements of computer 112 via bus 214. CPU 201 executes program instructions stored in RAM 202 and ROM 203 to perform various functions consistent with the present invention. Although computer 112 is described as being implemented with a single CPU 201, in alternative embodiments, computer 112 could be implemented with a plurality of processors operating in parallel or in series. There may be other components as well, but these are not shown to facilitate description of this invention. The hardware arrangement of this computer, as well as the other computers discussed in this specification is intentionally shown as general, and is meant to represent a broad variety of architectures, which depend on the particular computing device used. Data source 104 and data target 106 may be generally similar to computer 112 including a central processing unit, display device, memory and operator input device. Moreover, it will be appreciated that data source 104 and data target 106 may perform operations described herein as being performed by computer 112. Similarly computer 112 may perform operations described herein as being performed by data source 104 and data target 106.

Consistent with one embodiment, CPU 201 is programmed to receive data via communication link 116, and transmit data via communication link 118. Communication link 116 and communication link 118, in turn, receive data streams from data source 104 and interface 102, respectively, formatted according to respective communication protocols.

Interface 102 may read data from a data source located anywhere in the world, and communicate the data to a data target located anywhere in the world. Interface 102 is also preferably adapted to communicate with a first data source 104 and data target 106 over communication links 116 and 118 using FTP, and communicate with a second data source 104 and data target 106 over communication links 116 and 118 using HTTP.

If data source 104 is located on a host computer remote from interface 102, the communication link 116 may be a network connection. Alternatively, data source 104 may be local to the computer system 112, in which case communication link 116 may be an internal bus. Thus, data source 104 may be a data file located on computer system 112 or a data file located on a computer connected to the same local or wide area network as the computer system 112. Data source 104 might also be a web page accessible by computer system 112 via the Internet. In other words, embodiments of the present invention are not limited to any particular data sources or to any particular communication links.

Embodiments of the present invention also need not be limited to a particular type of data target. Data target 106 may be an application program, a file, an object or any other entity allowed by the environment in which interface 102 exists. Further, for example, target applications may fall into five basic categories: word processors, spreadsheets, databases, editors that come with Windows and web browsers. In one exemplary embodiment, the word processor category of data targets 106 include Microsoft Word™, Corel WordPerfect™ and Lotus Word Pro™, for example. The spreadsheet category of data targets 106 include Microsoft Excel™, Corel Quattro Pro™ and Lotus 1-2-3™, for example. The database category of data targets 106 include Microsoft Access™, Borland Paradox™ and Lotus Approach™, for example. The Windows editor category of data targets 106 include Wordpad™, Notepad™, Windows Write™, Paintbrush™ and Media Player™, for example. Data target 106 may also be a web site, and target file 110 may be an HTML or XML file 110 associated with data target 106. In this case, data target 106 may be read by a web browser such as Netscape Navigator™, Internet Explorer™ and Mosaic™, for example. In another embodiment, interface 102 may provide an HTML data target 106 that is a target file 110 in a text format. Embodiments of the present invention need not include and are not limited to these particular data targets or to targets having these particular formats.

In one embodiment of the present invention, computer system 112 implements a scripting tool as part of software 114. The scripting tool may be adapted to extract data from data source 104 and map the data onto target file 110. In another embodiment, the scripting tool may be adapted to extract data from data source 104, map the data onto target file 110 and then copy the data back onto data source 104. In yet another embodiment, the scripting tool may be adapted to extract data from data source 104, map the data onto target file 110 and output the data to an output file (not shown).

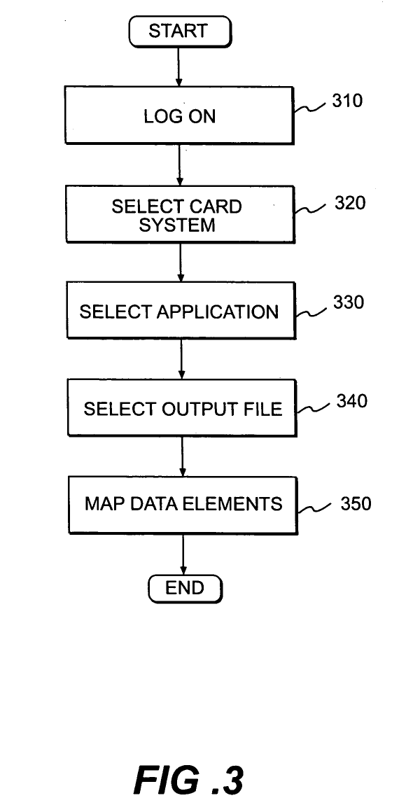

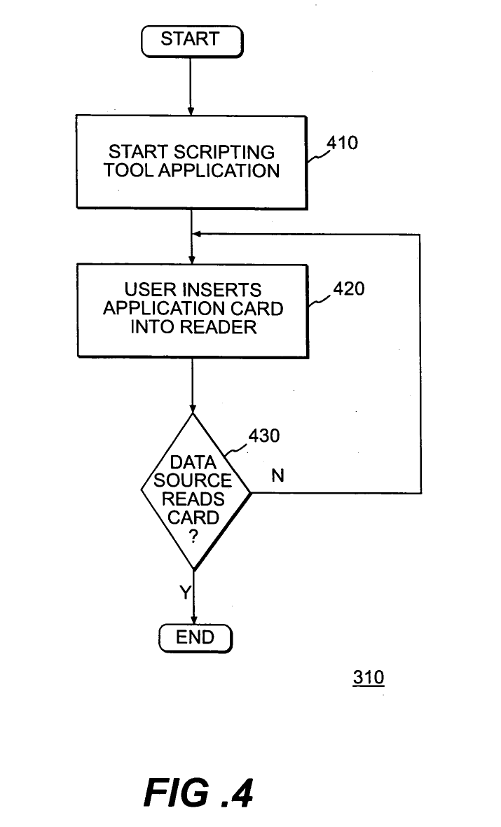

Before mapping data from data source 104 to target file 110 (and back), a script for mapping the data must be created. Referring now to FIG. 3, there is shown a flowchart of the steps performed in accordance with one embodiment of the present invention when the scripting tool maps data from data source 104 to target file 110. As shown in FIG. 3, processing begins in step 310 when a user logs onto the present system. Once the user is logged on, processing flows to step 320 where the user selects a card system. In one exemplary embodiment of the present invention, each smart card or data source may comprise multiple systems/applications (e.g., a banking/financial application, a security application for entry into a building or workplace, and a health-related application). After selecting a card system, the user selects an application on data target 106 (step 330). Processing then flows to step 340 when the user optionally selects an output file. As explained below, an output file may be a text file or a markup language file (HTML or XML) that may be created in conjunction with a target file. After the user optionally selects an output file, processing flows to step 350 where the data elements are mapped from the source file to the target file. The processing performed in FIG. 3 will now be further explained with reference to the flowcharts in FIGS. 4, 5, 8 and 9.

FIG. 4 shows a more detailed explanation of the functions performed in step 310. As shown in step 410, a user must first start the scripting tool application. Next, processing flows to step 420 where the user is prompted to insert an application card (smart card) into card reader or data source 104, and then remove the smart card from the reader. Data source 104 attempts to read the smart card (step 430). If the attempt to read the card is unsuccessful, processing flows to step 420 and the user is prompted to re-insert the smart card. If the attempt to read the card is successful, the processing flows to step 320 (FIG. 3). The process of inserting, removing and re-inserting is repeated until the system is able to read the smart card or a threshold number of failed attempts is exceeded.

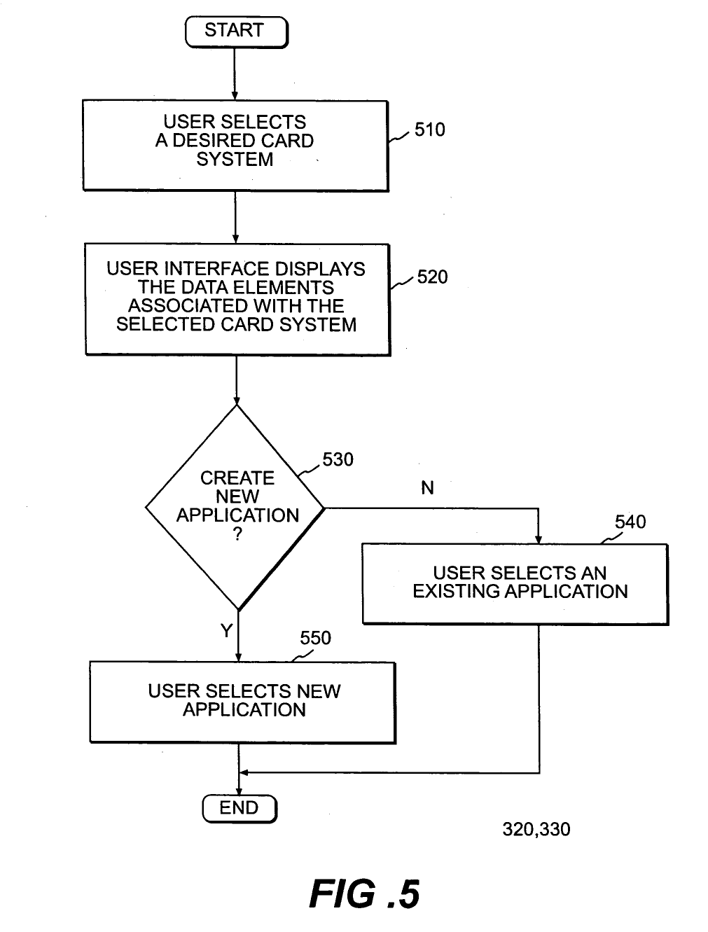

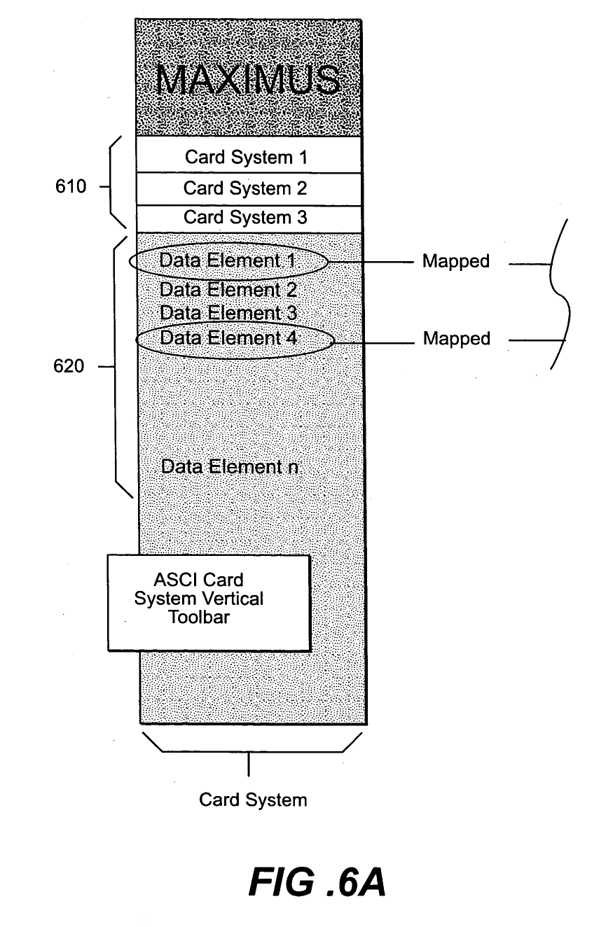

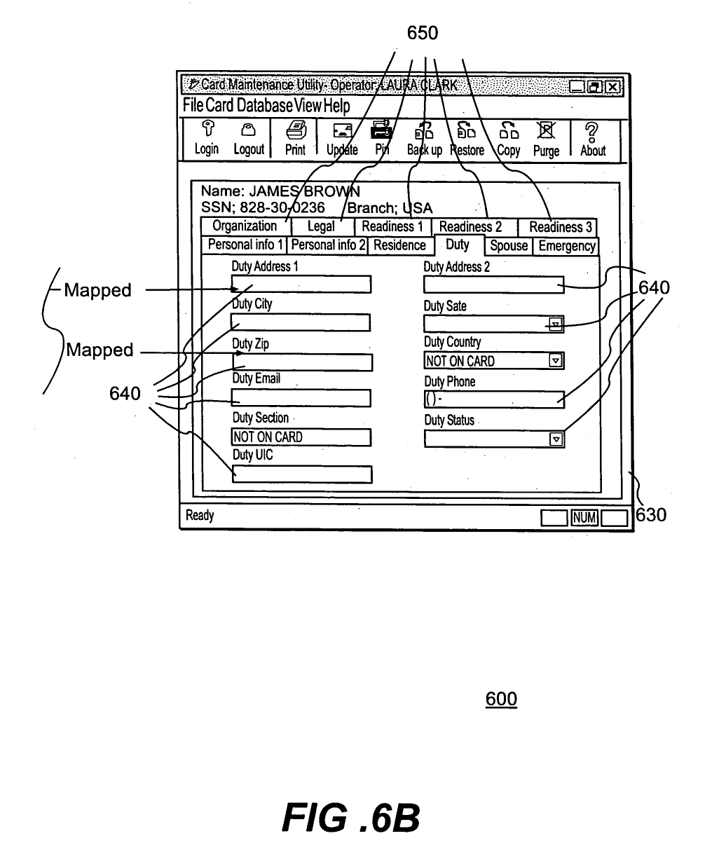

FIG. 5 is a more detailed flowchart of the process performed in steps 320 and 330 (FIG. 3) when the user selects a card system. To map smart card data elements to a selected application, the user selects a card system and then maps data elements unique to that card system to the selected application. As shown in FIG. 5, when a user selects a desired card system (step 510), a graphical user interface (GUI) displays data elements associated with the selected card system (step 520). The GUI may also display other information, such as a configuration listing of previously-mapped applications. An exemplary GUI consistent with this embodiment is shown in FIG. 6B, described below.

The user may decide whether to select a previously mapped application or create a new application (step 530). If the user decides to select a previously-mapped application, the user may manipulate mouse 220 or keyboard 218 to select an application listed in the configuration listing (step 540). If the user decides to create a new application, the user may manipulate mouse 220 or enter data via keyboard 218 to select a new application not in the application configuration listing (step 550).

FIG. 6A depicts an exemplary list of data that may be used in the process described in FIG. 5. This data may include, for example, a plurality of card systems 610 and corresponding data elements 620. In one embodiment of the present invention, each card system 610 may have one or more data elements 620 associated with it. The data shown in FIG. 6A may be stored in a database or other storage structure and may be presented to a user, for example, on a toolbar or pull-down list in a GUI. A toolbar is a collection of selectable buttons that allow a user to select functions such as desktop, application, or browser functions. Toolbars are typically displayed in a horizontal or vertical row around the edges of a GUI. A pull-down list is a menu of commands or options that appears when a user selects an item in a GUI, for example, by using a mouse.

FIG. 6B depicts an exemplary GUI 600 for selecting a card system in accordance with one embodiment of the present invention. In an embodiment of the present invention, GUI 600 may include data such as card systems 610 and corresponding data elements 620. GUI 600 contains an application data screen 630 with one or more associated tabs 650. A plurality of data entry fields 640 may be associated with each tab 650. To access a particular data entry field 640, the user selects one of the tabs 650 using a mouse or other pointing device, which causes the data entry fields associated with the selected tab to be displayed.

For example, to access the data entry fields associated with the Residence Tab, the user selects the Residence tab, placing it in the front of the display, revealing the data entry fields associated with it. Once the desired data entry fields are displayed, the user may manipulate a mouse or other pointing device to “drag-and-drop” selected data elements from a data source to the selected item in the data entry field. Drag-and-drop enables a user to move an image on a display screen by selecting the object, for example by clicking on the object with a mouse, and holding the object, for example by keeping the mouse button pressed down, while moving the object around the display screen. When the user releases the object, for example by releasing the mouse button, the object and its underlying data are copied to the new location, such as a data entry field. Drag-and-drop may be implemented, for example, by copying the dragged object to a cache, such as a clipboard, and then copying the object from the cache to the location selected when the user releases the mouse button.

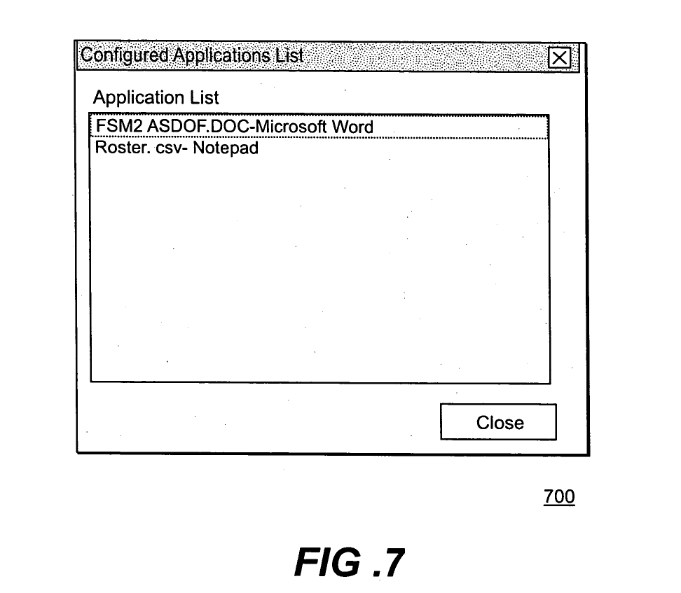

FIG. 7 shows a graphical depiction of a user interface 700 for selecting an existing application in accordance with one embodiment of the present invention. As shown, user interface 700 contains a display of a plurality of user-selectable files and the associated software application. Once a user selects an existing application or creates a new application and maps data elements to it, processing flows to step 340 (FIG. 3).

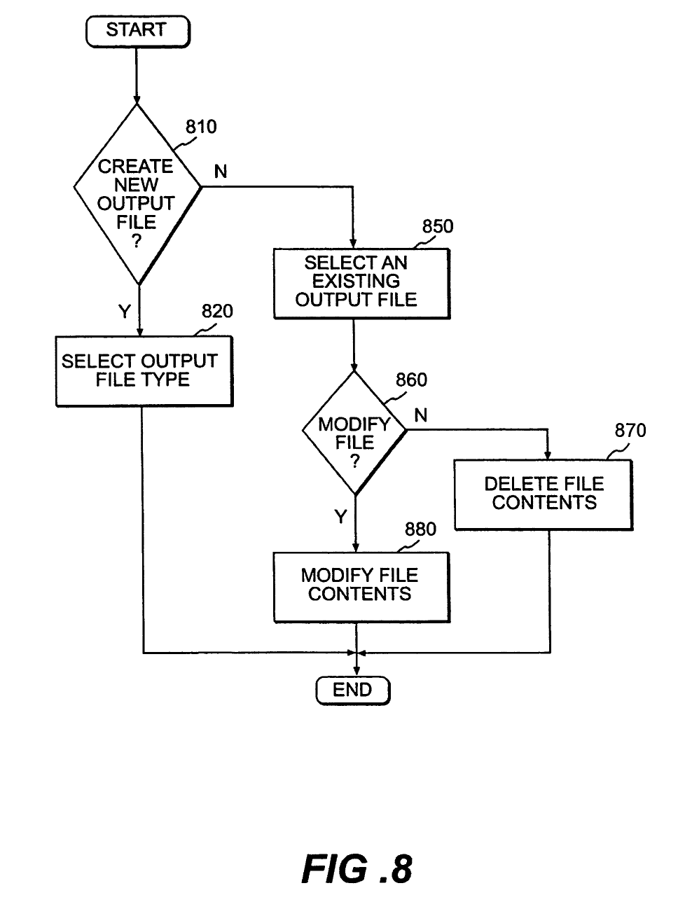

Turning now to FIG. 8, there is shown a more detailed flowchart of the steps performed in accordance with one embodiment of the present invention when a user selects an output file (step 340). By selecting an output file, a user may specify whether the read smart card data is to be directed to an output file in addition to, or instead of mapping the data to a specific remote application. In one embodiment, the output file may be a comma-delimited file or a markup language file (HTML or XML). The format of the output file may be identical to the target format of target file 110, and the output file may be encrypted.

Once an output file is created, a user may create a template from the output file and then apply this template to other source files (card systems) to verify that each source file is compatible with the existing output file. These “template files” consist of predefined formats or layouts. Examples are MS Excel comma-delimited files or MS Word forms. Once created, a template file may be opened and used “as-is” or it may be adjusted to satisfy a particular application.

The process of selecting an output file begins when the user is presented with the option to create a new output file or use an existing file (step 810). If the user chooses to create a new output file, processing flows to step 820, otherwise processing flows to step 850. In step 820, the user selects an output file type. In one embodiment, the user may select either a comma-delimited file or a markup language file (HTML or XML). Once the user selects the output file type, processing flows to step 350 (FIG. 3), where the user may map one or more data elements from the source file to the target file.

If the user does not choose to create a new file (step 810), processing flows to step 850 where the user may select an existing output file. In one embodiment, the user may first be presented with a menu that requests the file type (e.g., CSV, HTML, XML, etc.) of the existing output file. The user may then be presented with a list of existing files that satisfy the inputted file type. Once the user selects the existing file, processing flows to step 860 where the user is presented with the option to modify or delete contents of the selected file. If the user chooses to delete the contents of the selected file, processing flows to step 870, the contents of the file are deleted and processing flows to step 350. In one embodiment, the user may be prompted to confirm the selection before the file contents are deleted.

If the user chooses to modify the file, processing flows to step 880 where the user may modify the contents of the output file prior to mapping additional data elements to the output file. Once the user has completed modifying the output file, processing flows to step 350.

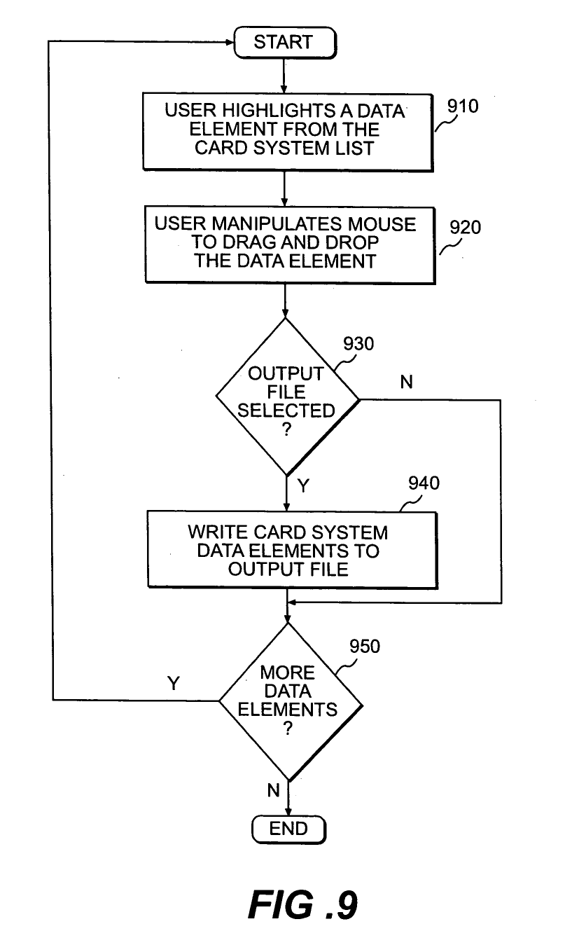

Turning to FIG. 9, there is shown a more detailed flowchart of the steps performed consistent with the present invention when a user maps data elements from the source data (e.g., the selected card system) to the target data (e.g., the desired application) (step 350). As shown, processing begins in step 910 when the user selects or highlights a data element 620 from the card system list depicted in user interface 600. After selecting the data element, processing flows to step 920 where the user manipulates mouse 220 or other pointing device (not shown) to “drag” the data element to a data entry field displayed in the desired application and then “drop” the selected item in the data entry field. Processing then flows to step 930 where a determination is made as to whether an output file was selected in step 340. If an output file was selected, processing flows to step 940. Otherwise, processing flows to step 950. In step 940, the data element previously selected is dropped onto a mapping pad associated with the output file. The mapping pad represents the collection of data elements that have been mapped to an output file. Each data element dropped onto the mapping pad is added to the end of the list. If the user wishes to rearrange the order in which the data elements are listed, he may also do so by utilizing the same drag-and-drop technique mentioned earlier. After updating the output file (if appropriate), processing flows to step 950 where the present system determines whether there are more data elements to be mapped. If there are, processing flows to step 910, otherwise processing terminates.

In one embodiment, a one-to-one relationship between each data element and each input object exists. That is, no more than one data element may be assigned (dragged-and-dropped) to a single input object. In another embodiment, a user may output a data element to more than one input object. When a data element is mapped to an input object, the data element may be converted into another format. In one embodiment of the present invention, there are at least four types of data conversions:

As-Is: There are two as-is options. First, the data element format is left intact as it is read from the data source. Second, the format may be related to an input object's mask. For example, a text box object displays the default text for a phone number entry in the format of [( )-]. When a phone number is read, the input object's mask simply places parenthesis and dash marks in the phone number to ease readability of the output file. Therefore, the default format presented to the user is representative of the input object's format.

Pre-defined data conversion formats: For each data element mapped to an object, the user will be provided with a list of data formats. For-example, a date input object in application ‘A’ requires that the date be in the format ‘mm/dd/yy’. The date read from the card, however, is in the format ‘mmddyyyy’. Depending on the input data element type, the end user may be provided with an appropriate list of formats from which to choose.

Customized data type formatting: This feature provides a user-defined data type format that allows the user to type in a format that is not listed in the pre-defined list.

Statement/Expression Builder: This feature provides a customizable statement and expression-building tool that can be used to customize an output based on a condition defined by the end user.

The first time an application, web page, or office product has been mapped, a configuration file, referred to as a GUI Mapping Module (GMM) is created for each screen, worksheet (Excel), form (Word), or web page. Whenever a user wishes to reconfigure an existing configuration file, the user may simply access and modify an existing GMM, which eliminates the need to redo the entire process from the beginning. For example, a user can access the sequential information for a single screen, web page, etc., including additional items, detailing the actions associated with each entry.

The user may then click on the mapped item or event and modify its behavior or remove it from the list of actions altogether. This may be accomplished through screen-to-file modularization. That is, a file exists for each screen, which then becomes a subset of the entire configuration file. Treating each file as a separate object allows the user to pick a particular screen for modification and reduces the amount of work required to modify an existing process.

For Microsoft Windows-based applications, screen-to-file modularization is accomplished by assigning constants to a particular application (e.g., the windows title and the embedded objects ID number), based on a tag format of the application. The mapping configuration formats for these objects are illustrated in Table 1 below.

TABLE 1

| Application | Tag Format |
|---|---|
| Windows | <Data Model>::<Data Element>::<Window |
| | Name>::<Object ID>::<Data Element Conversion |
| | Format>::<Write Flag> |
| Excel | <Data Model>::<Data Element>::<Window |
| | Name>::<Worksheet Name>::<Cell Address>::<Data |
| | Element Conversion Format> |

When combined, these data provide the foundation for mapping and scripting smart card data elements to any windows input control.

Once the data elements are mapped from the data source to the data entry fields, interface 102 generates a script that thereafter places the values associated with particular data elements into the appropriate data entry fields of a particular data target 106 whenever new data is received at data source 104. For example, once the data elements are mapped from a data source to the data entry fields of an application and a script is generated, subsequent instances of source data will automatically be placed into the appropriate data entry fields of subsequent records/lines of the application. In this way, entry fields in multiple applications may be associated to data elements on a smart card.

The ease with which multiple scripts may be generated allows many sources to be mapped by unsophisticated users in a small amount of time. This feature also allows embodiments consistent with the present invention to identify Windows dialogs, web pages, and the input objects contained in them. The data entry fields can then be associated with data elements in the source data.

In one embodiment, interface 102 creates a script for producing a mapping in a target application (e.g., Microsoft Office) by creating add-in components and embedding them in the target application. An add-in component contains the definitions of functions and data used to create the previously described mapping from the source data to the target data. In one embodiment, interface 102 may create an add-in component that is comprised of Visual Basic for Applications (VBA) code. In another embodiment, interface 102 may create code that references VBA code embedded in a particular application (e.g., MS Excel, Word, and PowerPoint). The VBA code could consist of messaging schemas that, in turn, communicate with interface 102.

For example, an Excel add-in could communicate with a data target 106 to map data elements to cell columns and rows. For example, “$A$1”=First Name, “$B$1”=Last Name, etc. In one embodiment, when target file 110 is a blank Microsoft Excel worksheet, each new column that is mapped to a data element may take on the name of the data element. For example, mapping the data element ‘First Name’ will result in a column being named ‘First Name’. The target data may also be template fields in data processing programs. This may be useful for filling in forms, building rosters, etc.

When mapping source data to a target application, error checking software in the target application may identify inconsistencies between the source and target data (e.g., a name from the source data is dropped into a zip code data entry field). In the event that errors are identified during the process of mapping data, an error log can be generated to assist with troubleshooting. The error log(s) may then be sent, via the Internet or email, for troubleshooting. In one exemplary embodiment, errors will be displayed in such a manner that the end user can quickly identify faults. An example of this would be the placement of highlighted text boxes next to input objects that are affected.

In one embodiment, the source data and the target data may be smart cards. In other words, a user may first map data from a smart card to an application, which may then be used to populate a second card. In another embodiment, a user may first map data from a smart card to an application, modify the mapped data and then update the smart card with the updated data. In one embodiment, a capability to limit a user's ability to modify one or more elements of card data may exist. That is, interface 102 may contain software that limits a user's ability to update one or more source or target data fields to prevent users from performing unauthorized applications.

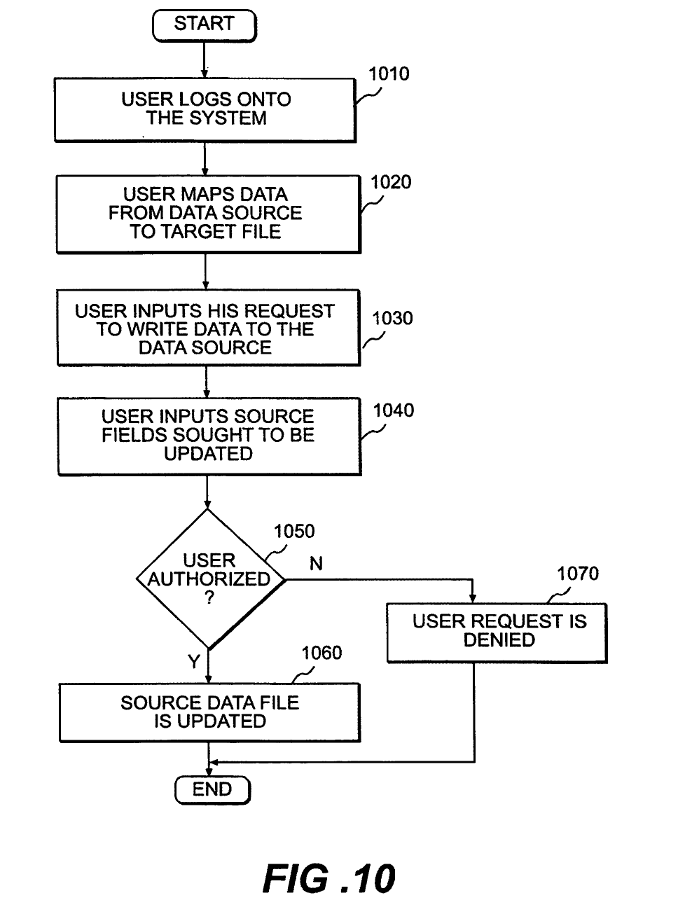

Referring to FIG. 10, there is shown a detailed flowchart that depicts the steps performed in accordance with one embodiment of the present invention when a user seeks to map data from target file 110 to data source 104. As shown, processing begins in step 1010 when the user logs onto the present system by inserting an application card (smart card) into card reader or data source 104. Once data source 104 has read the identifying data from the smart card, the user may then input his/her request to write data to the inputted smart card (step 1030). Prior to writing data to the inputted card, the user may map data elements from data source 104 to target file 110 (step 1020). The process for mapping data elements from a data source to a target file is depicted in FIG. 3. Once the user inputs a request to write data to the source application card, processing flows to step 1040 where the user is prompted to input the data fields sought to be updated. Interface 102 may then request the user input a user name and password to verify that the user is authorized to update the identified fields on the smart card (step 1050). If the user is authorized, processing flows to step 1060 where interface 102 then updates the fields on the smart card. If the user is not authorized to update the fields, processing flows to step 1070, and the user is informed that he/she is not authorized to perform the requested action, and processing terminates.

In one embodiment, a user may configure the mapping of objects and possibly a level of control over the events within the remote application. For instance, if a screen (Screen A) contains buttons that enable additional input objects on another screen (Screen B), then one embodiment may include a method that will populate the input objects from screen to screen. For example, screen A of an application contains a next button to proceed to screen B. The sequential pattern in this case might be:

1. Populate input objects from smart card for screen A.

2. User validates the information inserted on screen A, and then presses the ‘Next’ button.

3. The processing consistent with the present invention, which has been placed in a wait state listening for this action to occur, detects that the key/button event has occurred, moves to the next sequence of events which may be to populate additional input objects on screen B. This may be repeated back and forth between screens.

In one embodiment, it may be possible to limit the end user functionality to restrict operators from re-configuring or configuring an application. More specifically, processing consistent with the present invention may be configured to suppress any available functionality that is not required for the system to behave as a pure card service provider. That is, when a user places his/her card in a card reader or data source, processing consistent with the present invention appears to simply read the data, provide information to the user, respond to user queries, etc., without providing the user with the capability to read or write data stored on the card. This embodiment may include the capability to write the data stored on the card to an application when the card system is recognized and the data elements have previously been mapped to the application. Alternatively, this embodiment may write the data stored on the card to an output file when the card system is not recognized or the data elements on the card system have not been mapped to the application. In this way, all smart cards input at data source 104 will be compatible with data target 106. However, some data may have to be further manipulated prior to being associated with an application.

Although embodiments of the present invention have been described in which aspects are described stored in memory, one skilled in the art will appreciate that these aspects can also be stored on or read from other types of computer-readable media, such as secondary storage devices, like hard disks, floppy disks, or CD-ROMs; a carrier wave from the Internet; or other forms of RAM or ROM. Similarly, methods consistent with the present invention may conveniently be implemented in program modules that are based upon the flow charts in FIGS. 3-5 and 8-10. No particular programming language has been indicated for carrying out the various procedures described above because it is considered that the operations, steps and procedures described above and illustrated in the accompanying drawings are sufficiently disclosed to permit one of ordinary skill in the art to practice the instant invention. Moreover, there are many computers and operating systems, which may be used in practicing the instant invention and, therefore, no detailed computer program could be provided which would be applicable to these many different systems. Each user of a particular computer will be aware of the language and tools which are most useful for that user's needs and purposes.

Alternative embodiments will become apparent to those skilled in the art to which the present invention pertains without departing from its spirit and scope. Accordingly, the scope of the present invention is defined by the appended claims rather than the foregoing description.

We claim:

1. A method for communicating data from a plurality of data sources to a plurality of data targets in a data processing system having a plurality of connection mechanisms for establishing logical connections between data sources and data targets, the method comprising:
selecting one of a plurality of applications associated with a first data source, wherein each of the plurality of data source applications has a plurality of data elements;
selecting one of a plurality of applications associated with a data target, wherein each of the plurality of data target applications has a plurality of data entry fields;
mapping a data element from the first data source to a data entry field using a drag-and-drop operation; and
automatically associating a data element on a second data source corresponding to the mapped data element with the data entry field of the selected data target application.

2. The method of claim 1, further comprising copying a value stored in a data entry field to a data element associated with the second data source, provided the value stored in the data entry field has been mapped to the data element.

3. The method of claim 1, wherein mapping further comprises mapping a data element to a plurality of data entry fields, wherein the data element from the second data source is automatically associated with the plurality of data entry fields of the selected data target application.

4. The method of claim 1, wherein mapping further comprises generating a script that reads data from the first data source, transforms the data, and writes the transformed data to the data entry field when a previous mapping from the first data source to the selected data target application has been performed.

5. The method of claim 4, wherein the script writes the transformed data to an output file when a previous mapping from the first data source to the selected data target application has not been performed.

6. The method of claim 1, wherein the first data source is a smart card.

7. The method of claim 1, wherein the data target is a Microsoft Windows™-based application.

8. The method of claim 1, wherein mapping further comprises storing data elements of the second data source in an output file when a previous mapping from the first data source to the selected data target application has not been performed.

9. The method of claim 1, wherein mapping further comprises storing data elements of the second data source in an output file.

10. A method for communicating data from a plurality of data sources to a plurality of data targets in a data processing system having a plurality of connection mechanisms for establishing logical connections between data sources and data targets, the method comprising:
reading data from a data source;
if the read data has been mapped to a data entry field associated with a data target application using a drag-and-drop operation, associating the read data with the data entry field; and
if the read data has not been mapped to a data entry field associated with a data target application using a drag-and-drop operation, storing the read data in an output file.

11. The method of claim 10, wherein associating further comprises associating the read data with a plurality-of data entry fields corresponding to the data target application.

12. The method of claim 10, wherein the data source is a smart card.

13. The method of claim 10, wherein the output file is a text file.

14. The method of claim 10, wherein the output file is a hypertext markup language file.

15. The method of claim 10, wherein the data target application is a Microsoft Windows™-based application.

16. A computer-readable medium containing instructions executable by a computer for communicating data from a plurality of data sources to a plurality of data targets in a data processing system having a plurality of connection mechanisms for establishing logical connections between-data sources and data targets, the method comprising:
selecting one of a plurality of applications associated with a first data source, wherein each of the plurality of data source applications has a plurality of data elements;
selecting one of a plurality of applications associated with a data target, wherein each of the plurality of data target applications has a plurality of data entry fields;
mapping a data element from the first data source to a data entry field using a drag-and-drop operation; and
automatically associating a data element on a second data source corresponding to the mapped data element with the data entry field of the selected data target application.

17. The computer-readable medium of claim 16, further comprising copying a value stored in a data entry field to a data element associated with the second data source, provided the value stored in the data entry field has been mapped to the data element.

18. The computer-readable medium of claim 16, wherein mapping further comprises mapping a data element to a plurality of data entry fields, wherein the data element from the second data source is automatically associated with the plurality of data entry fields of the selected data target application.

19. The computer-readable medium of claim 16, wherein mapping further comprises generating a script, that reads data from the first data source, transforms the data, and writes the transformed data to the data entry field when a previous mapping from the first data source to the selected data target application has been performed.

20. The computer-readable medium of claim 19, wherein the script writes the data to an output file when a previous mapping from the first data source to the selected data target application has not been performed.

21. The computer-readable medium of claim 16, wherein the first data source is a smart card.

22. The computer-readable medium of claim 16, wherein the data target is a Microsoft Windows™-based application.

23. The computer-readable medium of claim 16, wherein mapping further comprises storing data elements of the second data source in an output file when a previous mapping from the first data source to the selected data target application has not been performed.

24. The computer-readable medium of claim 16, wherein mapping further comprises storing data elements of the second data source in an output file.

25. A computer-readable medium containing instructions executable by a computer for communicating data from a plurality of data sources to a plurality of data targets in a data processing system having a plurality of connection mechanisms for establishing logical connections between data sources and data targets, the method comprising:
reading data from a data source;
if the read data has been mapped to a data entry field associated with a data target application using a drag-and-drop operation, associating the read data with the data entry field; and
if the read data has not been mapped to a data entry field associated with a data target application using a drag-and-drop operation, storing the read data in an output file.

26. The computer-readable medium of claim 25, wherein associating further comprises associating the read data with a plurality of data entry fields associated with the data target application.

27. The computer-readable medium of claim 25, wherein the data source is a smart card.

28. The computer-readable medium of claim 25, wherein the output file is a text file.

29. The computer-readable medium of claim 25, wherein the output file is a hypertext markup language file.

30. The computer-readable medium of claim 25, wherein the data target application is a Microsoft Windows™-based application.

31. An apparatus for communicating data from a plurality of data sources to a plurality of data targets in a data processing system having a plurality of connection mechanisms for establishing logical connections between data sources and data targets, comprising:
means for reading data from a data source;
means for associating the read data with a data entry field associated with a data target application using a drag-and-drop operation, if the read data has been mapped to a data entry field; and
means for storing the read data in an output file, if the read data has not been mapped to a data entry field associated with a data target application using a drag-and-drop operation.
